(19) United States
(12) Patent Application Publication
(10) Pub. No.: US 2017/0193291 A1
(43) Pub. Date: Jul. 6, 2017

(54) System and Methods for Determining Language Classification of Text Content in Documents

(71) Applicant: Ryan Anthony Lucchese, Elizabeth, CO (US)

(72) Inventor: Ryan Anthony Lucchese, Elizabeth, CO (US)

(21) Appl. No.: 14/984,879

(22) Filed: Dec. 30, 2015

(51) Int. Cl. G06K 9/00; G06F 17/30; G06F 17/27

(52) U.S. Cl. CPC G06K 9/00456; G06F 17/2715; G06F 17/30598

(57) ABSTRACT

A method of classifying a document according to text content includes identifying a plurality of n-grams from the document for creating a shared vocabulary, the shared vocabulary including a set of n-grams from a plurality of training documents each associated with a text content type and stored in a double-array prefix tree; referencing the shared vocabulary, generating a first vector and a plurality of second vectors, the first vector corresponding to a frequency of each n-gram in the shared vocabulary in the document and each of the plurality of second vectors corresponding to a frequency of each n-gram in the shared vocabulary in each training document; determining a highest cosine value among each of a plurality of angles generated between the first vector and each second vector representative of each training document; and automatically classifying the document as having a text content type most similar to the training document represented by the second vector having the determined value.

### CROSS REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to classifying documents and, more particularly, to determining one or more language classifications of document text.

2. Description of the Related Art

Classifying documents based on their text content typically involves character recognition and interpretation. While character recognition systems may be apparent in the art, computer-generated systems and methods for interpreting recognized characters, into relevant information may present a problem as the resulting information may not meet a requestor's expected output.

In particular, when there are more common n-grams present between a document and a training document, it may be reasonable to infer that the document includes the same languages as the training document. However, frequently used n-grams in a document often give less information about the document compared to rare n-grams. Text content in a document may also be a combination of different languages. Yet other factors to be considered in the classification process include the amount of memory and the processing time that may be consumed in performing the comparison of documents. Since the number of training documents to be compared with affects classification results, having more training documents to compare with may require larger memory space or may result for a classification engine to execute the classification process at a longer rate.

Accordingly, there is a need for a system and methods for classifying a document based on one or more languages detected to be used therein. Methods of storing and retrieving a plurality of documents in memory for comparison with a document are also needed. There is also a need for methods of document classification providing results that are meaningful to a requestor.

### SUMMARY

A system and methods for classifying documents and, more particularly, to determining one or more language classifications of document text are disclosed.

One example method of classifying a document according to text content includes identifying a plurality of n-grams from the document for creating a shared vocabulary, the shared vocabulary including a set of n-grams from a plurality of training documents each associated with a text content type and stored in a double-array prefix tree; referencing the shared vocabulary, generating a first vector and a plurality of second vectors, the first vector corresponding to a frequency of each n-gram in the shared vocabulary in the document and each of the plurality of second vectors corresponding to a frequency of each n-gram in the shared vocabulary in each training document; determining a highest cosine value among each of a plurality of angles generated between the first vector and each second vector representative of each training document; and automatically classifying the document as having a text content type most similar to the training document represented by the second vector having the determined value.

One example method of detecting language in a document includes determining a plurality of n-grams in the document for creating a common dictionary including a set of n-grams from a plurality of training profiles each associated with a language or a character encoding and stored in a double array prefix tree; using the common dictionary, generating a first vector and a plurality of second vectors, the first vector corresponding to a frequency of each n-gram in the common dictionary in the document and each of the plurality of second vectors corresponding to a frequency of each n-gram in the common dictionary in each training profile; and computing a cosine value for each angle generated between the first vector and each of the plurality of second vectors, wherein a ranking of the computed cosine values from highest to lowest represents a level of presence of one of a language or character encoding in the document.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows one example embodiment of a system 100 including a classification engine 105 for determining language classification of a document 130 based on detected text content.

FIG. 2 shows a flowchart of one example method for creating or generating a training profile for each training document for comparison with a document.

FIG. 3 shows a flowchart of one example method for automatically determining language classification of a document based on its text content.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes.

Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is therefore, not to be taken in a limited sense, and the scope of the present disclosure is defined by the appended claims.

Also, it is to be understood that the phraseology and terminology used herein is for the purpose of description and should not be regarded as limiting. The use herein of “including”, “comprising”, or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a classification engine and methods for automatically determining language classification of a document based on its text content. The methods may include comparing cosine similarities between vectors representative of the document and a plurality of training documents, as will be further described in detail below.

In the present disclosure, a language may refer to any standard of written communication, such as English, German, and Spanish. In another aspect, a language may also refer to a character encoding scheme demonstrating character sets coded into bytes for computer recognition. A character encoding scheme may be an ASCII, EBCDIC, UTF-8, and the like. Other types of languages for representing text characters in a document may be apparent in the art.

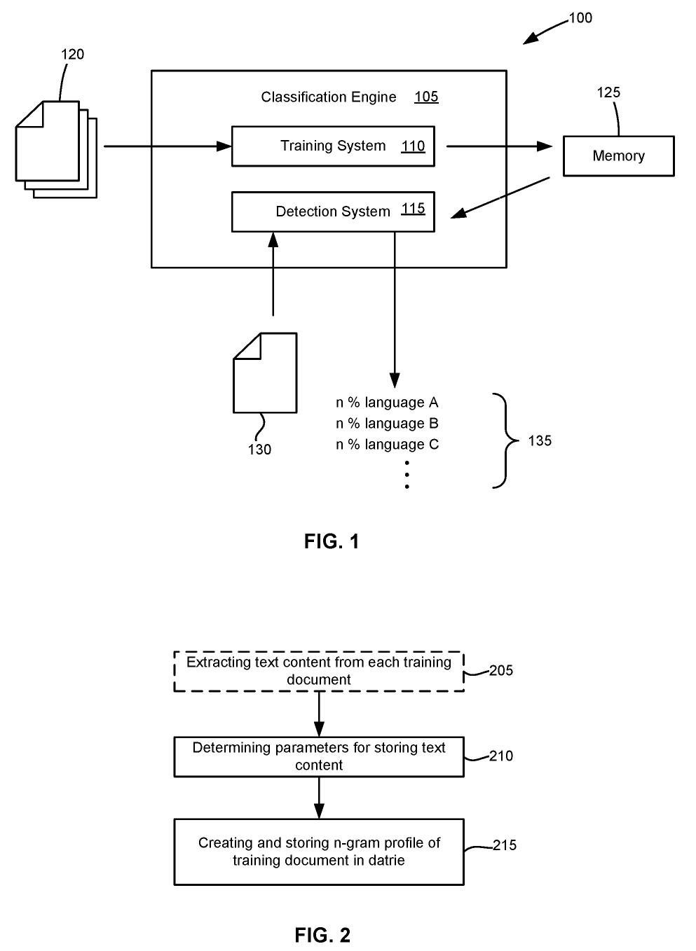

FIG. 1 shows one example embodiment of a system 100 including a classification engine 105 for determining language classification of a document 130 based on detected text content. Classification engine 105 may include a training system 110 and a detection system 115. Training system 110 may store a plurality of training documents 120 to a memory 125 for comparison with document 130. Upon such determination, an output 135 indicative of a language classification of document 130 may be generated by classification engine 105. Combinations and permutations for the elements in system 100 may be apparent in the art.

Connections between the aforementioned elements in FIG. 1, depicted by the arrows, may be performed in a shared data bus of a computing device. System 100 may be performed in a computing device. Classification engine 105 may be an application operative to execute on the computing device. Alternatively, the connections may be through a network that is capable of allowing communications between two or more remote computing systems, as discussed herein, and/or available or known at the time of the filing, and/or as developed after the time of filing. The network may be, for example, a communications network or network/communications network system such as, but not limited to, a peer-to-peer network, a Local Area Network (LAN), a Wide Area Network (WAN), a public network such as the Internet, a private network, a cellular network, and/or a combination of the foregoing. The network may further be a wireless, a wired, and/or a wireless and wired combination network.

Classification engine 105 may be computer-executable program instructions stored on a computer-readable medium, such as a hard disk. It may be a module or a functional unit for installation on a computing device and/or for integration to an application. In one example embodiment, classification engine 105 may be an application residing on a server for activation thereon. Classification engine 105 may include a combination of instructions of training system 110 and detection system 115. Training system 110 and detection system 115 may be operative to perform respective functions; however, information generated on one system may be utilized by another. For example, training documents 120 from training system 110 may be used by detection system 115 for comparison with document 130. On the other hand, data gathered by detection system 115 during or after a comparison process may be used to improve training system 110.

Training system 110 may include one or more computer-executable program instructions (i.e., program method or function) for storing training documents 120. In one example embodiment, each training document 120 may be a character set corresponding to a particular language. For example, a first training document 120 may be a set of English words such as, for example, a downloadable online dictionary, while a second training document 120 may be a set of characters each corresponding to byte codes for recognition by a computing device.

In another example embodiment, each training document 120 may be a record including text characters corresponding to a particular language. A training document 120 may be, for example, an e-mail, a file, or any other electronic means having text content that is representative of a particular language. Training system 110 may include program instructions for identifying and/or extracting text content from each training document 120, i.e., optical character recognition systems. Training system 110 may further include program instructions for identifying a pattern from text content on each training document 120. A pattern may be a standard pattern and may refer to how each text character or group of characters are arranged relative to the rest of the text content in the document. For example, an e-mail message or other electronic document may be entered into training system 110. Alternatively, training document 120 may be a non-electronic document, such as written or printed documents. Regardless of its form, it may be apparent in the art that training document 120 is representative of any text content and/or delivery means to be utilized in the classification process.

As shown in FIG. 1, training system 110 may be communicatively coupled to memory 125 which may be any computer-readable storage medium for storing data. In one example embodiment, memory 125 may be a database for saving training document 120 and/or its corresponding text content. Alternatively, memory 125 may be a storage section on a series of servers included in training system 110. Training system 110 may store plurality of training documents 120 to memory 125. Information associated with each training document 120 which includes text content therein may be stored to memory 125.

Training system 110 may include one or more program instructions for further processing each training document 120. Processing training documents 120 may include determining a language represented by the training documents. An administrator of training system 110 may indicate to training system 110 the language the text content in training document 120 is representative of or corresponding to.

Processing training documents 120 may further include generating from the determined text content a plurality of n-grams which refer to a contiguous sequence of n number of characters from a given string. A length of n-grams to be generated from each training document 120 may be predetermined. The administrator of training system 110 may determine a minimum or a maximum n-gram length for each training document 120.

Determining the minimum or maximum n-gram length may be based on the language identified to be corresponding to text content in training document 120 or that training document 120 is representative of.

For example, a document having English content (training document 120) may generate n-grams that have a length of 4 (4-grams) as text characters that have a length lesser than that may be indicated to be of no significance by the administrator. Each term in training document 120 is identified and split into n-grams for creating an n-gram or training profile. It may be apparent in the art that for each language represented by and/or corresponding to each training document 120, the minimum or maximum n-gram length may vary.

Detection system 115 may include one or more computer-executable program instructions for determining a similarity between document 130 and any of training documents 120. Detection system 115 may be communicatively coupled to memory 125 for referencing stored training documents 120. Detection system 115 may further include one or more program instructions for (1) determining a common set of n-grams between document 130 and each training document 120; (2) generating vectors based on a frequency of each common n-gram in the document 130 and in each training document 120; and (3) calculating cosine similarities between each angle generated between document 130 and each training document 120. It will be appreciated by those skilled in the art that the functions of determining, of generating, and of calculating may be performed by detection system 115 even if not performed in modular model and that other modules or functional units may be included.

With continued reference to FIG. 1, document 130 may be an electronic or a non-electronic document including text for classification. Document 130 may be, for example an essay written on a paper, an electronic message having encoded text content or any other means for delivering text content. Document 130 may be retrieved from a server communicatively coupled to classification engine 105 or received from a computing device. In one example, a requestor may transmit document 130 to classification engine 105 in order to determine its language classification based on its text content. In other example embodiments, transmitting document 130 to classification engine 105 may be performed automatically. Classification engine 105 may then automatically process document 130 and generate output 135. How output 135 may be produced from classification engine 105 may be preset.

FIG. 2 shows a flowchart of one example method 200 for creating or generating a training profile for each training document 120 for comparison with document 130. Method 200 may be performed by training system 110. At optional block 205, text content from each training document 120 may be extracted. As training document 120 may be in electronic or non-electronic form, text content on training document 120 may be readily available or still needed to be retrieved, respectively. Methods for extracting text content from each training document 120 are apparent in the art.

One or more parameters for storing the text content in memory 125 may then be determined at block 210. Determining the one or more parameters to be used in storing the text content may include identifying a minimum length of n-grams that are indicative of a language in training document 120. Each training document 120 may differ in one or more predetermined parameters. In one example embodiment, it may be preset that for a training document 120, an n-gram may have at least a length of 5. Terms or n-grams having a length lesser than 5 may be determined to be not relevant in representing document 120 or are discarded.

At block 215, a training or n-gram profile for each training document 120 may be created and stored in memory 125. Each n-gram profile may be a vocabulary for each language that training document 120 is representative of. A training or n-gram profile of a training document 120 may also represent a set of terms or n-grams relevant to the training document.

In the present disclosure, each n-gram profile (set of n-grams) of each training document 120 is stored in a double-array prefix tree (datrie) data structure. Datrie is a specialized compression algorithm of a prefix tree that preserves n-gram look-up time. Each datrie generated includes the n-gram profile of the corresponding training document 120 as well as a number of occurrences for each n-gram in the training document. In particular, each a node in a datrie may be an n-gram (e.g., “APPLE”), extending to other n-grams having lengths longer by another character (e.g., “APPLET” and “APPLES”). Each node (“APPLE”, “APPLET”, and “APPLET”) may also include a corresponding frequency in the training document 120. A collection of datries stored in memory 125 may then be used for referencing of detection system 115. Other information associated with each training document 120 may also be stored in memory 125. Information related to each training document 120 may also be added.

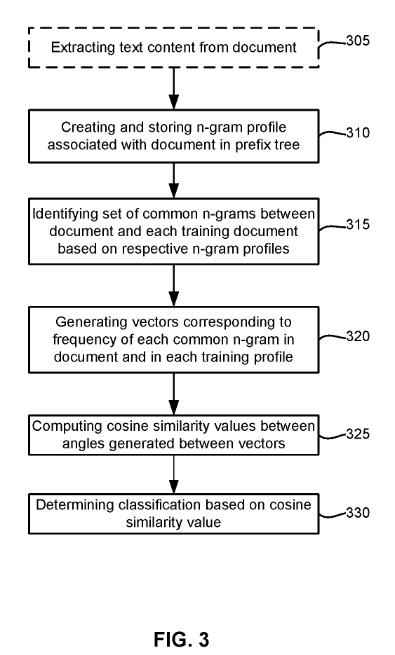

FIG. 3 shows a flowchart of one example method 300 for automatically determining a language classification of document 130 based on its text content. Method 300 may be performed by detection system 115 and may include generating an n-gram profile of document 130 for comparison with each training or n-gram profile corresponding to training documents 120 in memory 125. It may be apparent in the art that the detection process may not be performed without one or more training profiles on training system 110 to be compared with. While detection system 115 may be dependent on training or n-gram profiles generated by training system 110 for it to perform its function/s, it may include one or more program instructions to communicate with training system 110 in order to develop the current corpus or collection of training profiles. For example, an n-gram profile corresponding to document 130 generated by detection system 115 stored as a training profile. The n-gram profile corresponding to document 130 generated may be stored in memory 125 and may replace or be integrated to a previously stored training profile.

At optional block 305, text content is extracted from document 130. With respect to block 205 of FIG. 2, text content from document 130 may either be readily available or still needed to be retrieved. In one example embodiment, one or more image processing techniques may be performed to extract its text content for use in the classification process. Alternatively, document 130 may be an e-mail message having text content that may be automatically used in the classification process.

At block 310, an n-gram profile may be created using the text content of document 130. Creating an n-gram profile representative of or corresponding to document 130 may include determining a set of n-grams from its text content. Such determination may be performed by identifying a minimum length of n-grams that may be used in the creation of the n-gram profile. N-grams to be used in generating the n-gram profile may also be manually picked out by the requestor. One or more program instructions for automatically determining a set of n-grams from the text content based on a predetermined set of relevant n-grams may also executed. Other parameters may also be preset in determining n-grams to be included or not included in the n-gram profiles. In an alternative example embodiment, all terms from the extracted text content may be included in creating the n-gram profile.

Determining a set of n-grams representative of document 130 may also include identifying how important a term or n-gram is to the document. Identifying term importance may be based on its number of occurrences within the document as well as its rarity of use on document 130. The identification may be performed using one or more statistical measures, such as, for example, using term frequency—inverse document frequency (tf-idf). A weight of each term in a document may be predetermined.

In one example embodiment, the n-gram profile may be stored as a prefix tree data structure, such that, for example, each n-gram or character consisting it may be a node on the prefix tree data structure. A frequency of each n-gram in document 130 may also be included in the prefix tree. Alternatively, an n-gram profile of document 130 may be generated and stored using a datrie.

For each training or n-gram profile, a set of n-grams common with the n-gram profile of document 130 (from block 310) may be identified at block 315. The set of common n-grams may include a plurality of n-grams that are shared between document 130 and each training document 120 based on their respective n-gram profiles. Common n-grams may be used in determining a similarity of languages used in text contents between document 130 and each training document 120.

At block 320, a plurality of vectors corresponding to a frequency of each common n-gram in document 130 may be generated. A plurality of vectors corresponding to a frequency of each common n-gram in each training profile may also be generated for comparison with the vectors associated with document 130.

At block 325, a cosine similarity value for each angle between a vector corresponding to document 130 and another vector corresponding to a training document 120 may be computed. Computing the cosine similarity of the documents based on the generated angles may include calculating a dot product of the two vectors as well as their magnitude (i.e., Euclidean distance). Specifically, the cosine similarity value of the documents—document 130 and training document 120—may be computed using the following formula:

similarity (A, B)=cos (θ)=(A·B)/(|A| |B|)

where A and B represent the vectors, and calculating the cosine similarity value includes dividing the dot product (herein represented as A·B) with the Euclidean distance of the vector (herein represented by |A| |B|). The resulting cosine similarity value may range from 1 (exactly the same) to −1 (exactly opposite). However, it may be apparent in the art that no two documents may be exactly opposite and 0 may be set as the minimum value for cosine similarity.

In one example embodiment, the resulting cosine similarity values may be ranked. For example, cosine similarity values of document 130 to each training document 120 as represented by their corresponding vectors may be ranked from highest to lowest. A highest to lowest ranking of the computed cosine similarity values may be indicative of a level of similarity of document 130 with training document 120.

In another example embodiment, the resulting cosine similarity values may be normalized. Each resulting value may also be represented as a percentage value. The percentage value may be indicative of a level of presence of n-grams from training document 120 in document 130, thus indicative of a similarity of document 130 with training document 120.

Based on the ranking and/or normalized cosine similarity values, one or more language classifications of document 130 may be determined. Classification engine 105 may classify document 130 based on the maximum computed cosine similarity value. Alternatively, document 130 may be classified according to its n % similarity with one or more languages, such as that shown by output 135 in FIG. 1. This way, document 130 may be automatically classified according to one or more languages determined to be present upon comparison with training documents 120.

It will be appreciated that the actions described and shown in the example flowcharts may be carried out or performed in any suitable order. It will also be appreciated that not all of the actions described in FIGS. 2 and 3 need to be performed in accordance with the example embodiments and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of classifying a document according to text content, comprising:
identifying a plurality of n-grams from the document for creating a shared vocabulary, the shared vocabulary including a set of n-grams from a plurality of training documents each associated with a text content type and stored in a double-array prefix tree;
referencing the shared vocabulary, generating a first vector and a plurality of second vectors, the first vector corresponding to a frequency of each n-gram in the shared vocabulary in the document and each of the plurality of second vectors corresponding to a frequency of each n-gram in the shared vocabulary in each training document;
determining a highest cosine value among each of a plurality of angles generated between the first vector and each second vector representative of each training document; and
automatically classifying the document as having a text content type most similar to the training document represented by the second vector having the determined value,
wherein at least one of the identifying, the generating, the determining, and the classifying is performed by a processor.

2. The method of claim 1, wherein the identifying the plurality of n-grams includes determining a set of n-grams to be included in the shared vocabulary.

3. The method of claim 1, wherein the identifying the plurality of n-grams includes selecting an n-gram in the document that is not included in a predetermined set of stop n-grams for inclusion in the shared vocabulary.

4. The method of claim 1, wherein the determining the highest cosine value includes categorizing a cosine value for an angle generated between the first vector and a second vector to a predetermined range of values indicative of a similarity with a text content type in a training document.

5. The method of claim 1, wherein the determining the highest cosine value includes ranking a cosine value for the plurality of angles generated between the first vector and each second vector from highest to lowest, the ranking indicative of a similarity between the document and each training document.

6. The method of claim 1, wherein the determining the highest cosine value includes normalizing a cosine value for each angle generated between the first vector and each second vector, the normalized cosine value indicative of a similarity probability value.

7. A method of detecting language in a document, comprising:
determining a plurality of n-grams in the document for creating a common dictionary including a set of n-grams from a plurality of training profiles each associated with a language or a character encoding and stored in a double array prefix tree;
using the common dictionary, generating a first vector and a plurality of second vectors, the first vector corresponding to a frequency of each n-gram in the common dictionary in the document and each of the plurality of second vectors corresponding to a frequency of each n-gram in the common dictionary in each training profile; and
computing a cosine value for each angle generated between the first vector and each of the plurality of second vectors,
wherein a ranking of the computed cosine values from highest to lowest represents a level of presence of one of a language or character encoding in the document, and
wherein at least one of the determining, the generating, and the computing is performed by a processor.

8. The method of claim 7, wherein the determining the plurality of n-grams includes selecting an n-gram in the document for inclusion in the common dictionary according to a predetermined n-gram length.

9. The method of claim 7, wherein the generating the first vector and each of the plurality of second vectors includes forming each vector according to a frequency of each n-gram in the common dictionary in the document and each training profile, respectively, multiplied to a preset weight of each n-gram in the common dictionary.

10. The method of claim 7, wherein the computing the cosine value includes normalizing a cosine value for each angle generated between the first vector and each second vector.

11. The method of claim 10, further comprising ranking the normalized cosine values from highest to lowest.

12. The method of claim 7, further comprising sorting each computed cosine value according to a plurality of cosine value ranges indicative of a similarity with one of a language or a character encoding in a training profile.

13. A document classification engine according to language, comprising:
a training system including at least one processor and a memory for storing in a double-array prefix tree a plurality of training profiles for comparison with a document, each training profile representative of a language; and
a detection system communicatively coupled with the training system for referencing the plurality of training profiles, the detection system having:
a vector generator module for creating a first vector representative of an n-gram frequency in the document and a plurality of second vectors each representative of an n-gram frequency in each training profile, the first and each second vector created relative to a set of shared n-grams of the document and each training profile; and
a cosine similarity module for determining a set of cosine values for each angle generated between the first vector and each second vector, the set of cosine values indicative of a similarity of a text content in the document with a language in a training profile,
wherein the document is classified based on a ranking of the determined set of cosine values from highest to lowest.

14. The document classification engine of claim 13, wherein the detection system further comprises a normalization module for normalizing the determined set of cosine values, the normalized values indicative of a similarity probability value of the document to the plurality of training profiles.

15. The document classification engine of claim 13, wherein the detection system further comprises a module for converting the determined set of cosine values to information recognizable by a user.

16. The document classification engine of claim 13, wherein the detection system further comprises an extraction module for extracting text content from a document and determines a set of n-grams from the extracted text content, the set of n-grams to be included in the set of shared n-grams.

17. The document classification engine of claim 16, wherein the set of n-grams from the extracted text content in the document is stored in a prefix tree.

18. The document classification engine of claim 13, wherein the training system includes a set of n-grams for each training profile indicative of a language.

19. The document classification engine of claim 17, wherein the detection system stores the set of n-grams in the document in a prefix tree.

20. The document classification engine of claim 13, wherein the first and the plurality of second vectors are created based on a frequency of each n-gram in the set of shared n-grams in the document multiplied to a preset weight of each n-gram.
